(19) United States
(12) Patent Application Publication
(10) Pub. No.: US 2001/0019297 A1
(43) Pub. Date: Sep. 6, 2001

(54) Rod ignition transformer for internal-combustion engines

(76) Inventors: Linhard Niemetz, Rednitzhembach (DE); Wilfried Schmolla, Dietzenbach (DE); Harald Winter, Hattersheim (DE)

Correspondence Address: VENABLE, Post Office Box 34385, Washington, DC, 20043-9998, US

(21) Appl. No.: 09/741,093

(22) Filed: Dec. 21, 2000

(30) Foreign Application Priority Data
Dec. 23, 1999 (DE) 199 62 368.6-34

(51) Int. Cl. H01F 27/02

(52) U.S. Cl. 336/92

(57) ABSTRACT

The rod ignition transformer including an integrated low-voltage connector to the on-board network supply, and an integrated high-voltage connector to the spark plug, both accommodated in a housing. In the housing, the primary coil and the secondary coil surround a central core comprising a ferromagnetic powder composite material. A magnetic feedback member is formed from a highly-permeable magnetic material having low eddy current losses. The magnetic feedback member preferably is formed from ferrite.

### CROSS-REFERENCE TO RELATED APPLICATION

This application claims the priority of German Application No. 199 62 368.6, filed Dec. 23,1999, which is incorporated herein by reference.

### FIELD OF THE INVENTION

The invention relates to a rod ignition transformer having a housing, into which a low-voltage connector and a high-voltage connector are integrated, a central core on which a primary coil is wound or disposed, a coil form that surrounds the primary coil and on which a secondary coil is wound or disposed, and a magnetic feedback that comprises a highly-permeable magnetic material having low eddy current losses.

### BACKGROUND OF THE INVENTION

A generic rod ignition transformer is known from U.S. Pat. No. 5,632,259. U.S. Pat. No. 5,632,259 describes a cylindrical rod ignition transformer having a housing and an integrated spark plug connector that is inserted directly onto the spark plug. A primary coil and a secondary coil surround a central core. A magnetic feedback surrounds the two coils. The central core is connected to the magnetic feedback via a magnetic bridge. To avoid eddy current losses, all of the parts that conduct a magnetic flux are embodied as laminar sheets. Laminar sheets keep the eddy currents small with conventional rates of change of the magnetic flux. With very rapid changes in flux, or with very high rates of change of the magnetic flux, however, the laminar sheets can no longer adequately suppress the eddy currents in the flux-conducting magnetic parts of the ignition transformer. Consequently, with very rapid rates of change in flux, energy losses occur in the flux-conducting material, decreasing the efficiency of the ignition coil.

The developmental trend in spark-ignited internal-combustion engines is toward increasingly compact ignition transformers. The technical development also favors the individual handling of each combustion chamber. The central generation of an ignition voltage that is subsequently distributed to the individual spark plugs with electrical or electronic circuits is being increasingly replaced by ignition transformers that generate the ignition separately for each combustion chamber. In this instance, the attainable compactness of the ignition transformers is of considerable significance. The required space for an ignition transformer is intended to increase the required space for a conventional spark plug as little as possible.

Typically, ignition transformers must generate a high voltage of 30 kV for initializing the ignition process. In contrast, typically about 500 V suffice to maintain the ignition spark for the burning time of the spark. Usually, the required energy is taken from the magnetic field of the ignition transformer to generate the ignition voltage of 30 kV. Eddy losses occurring in the ignition transformer must additionally be stored in the ignition transformer in the form of magnetic energy.

### BRIEF SUMMARY OF THE INVENTION

It is the object of the invention to provide a rod ignition transformer and an ignition unit that can have a very compact design and are also capable of generating an ignition voltage of up to 30 kV with the smallest possible quantity of stored energy, thereby avoiding eddy losses at high rates of change in flux.

According to the invention, this object is accomplished by a rod ignition transformer having a housing, into which a low-voltage connector and a high-voltage connector are integrated, a central core on which a primary coil is disposed, a coil form that surrounds the primary coil and on which a secondary coil is disposed, a magnetic feedback member that comprises a highly-permeable magnetic material having low eddy current losses, and wherein the central core is formed from a ferromagnetic powder composite material. Further advantageous embodiments and features are disclosed and discussed.

The rod ignition transformer of the invention includes a low-voltage connection to the on-board network supply, and an integrated high-voltage connection to the spark plug, both accommodated in a housing. In the housing, the primary coil and the secondary coil surround a central core comprising a ferromagnetic powder composite. A magnetic feedback path comprises a highly-permeable magnetic material having low eddy current losses. The magnetic feedback path preferably comprises ferrite. The powder composite preferably has a relative magnetic permeability μ_{R} greater than 100, a specific electrical resistance p in a range of 0.5 Ωcm to 1*10⁴ Ωcm and, at 0.1 Tesla and 100 kHz, specific re-magnetization losses of less than 100 μWs/cm³ (microwatt seconds per cubic centimeter).

The following advantages are attained with the invention:

The powder composite reliably suppresses the eddy current losses in the parts that conduct the magnetic flux, even at high to very high rates of change in flux. The invention is advantageously employed with rates of change in flux of dφ/dt greater than or equal to 15 V (Volts). Typically, rates of change in flux of 4 V occur in conventional ignition transformers. The use of the powder composite material improves the energetic efficiency of the ignition transformer. Furthermore, less magnetic energy must be stored in the ignition transformer for attaining the typical ignition voltage of 30 kV.

Workpieces comprising a powder composite material can be molded and produced as pressed parts. These workpieces can thus be produced inexpensively, on the one hand, and, on the other hand, complicated workpiece shapes can be realized simply.

An advantage of the preferred embodiment of the ferrite magnetic feedback path is that the feedback simultaneously acts as an electrical insulator, which can reduce the cost for separate insulators. The structural size of the rod ignition transformer can thereby be advantageously reduced.

A rod ignition transformer according to the invention, or an ignition unit having a core comprising a ferromagnetic powder composite material and a magnetic feedback path comprising a highly-permeable magnetic material with low eddy current losses, is advantageously suited for use in ignition systems for motor vehicles in which the ignition transformer generates a self-induction voltage of up to 30 kV with the least possible stored energy, and is subsequently operated with AC voltage. The frequency of the AC voltage is preferably greater than 10 kHz (kilohertz). At these frequencies, it is especially advantageous to avoid eddy current losses with the employed magnetic materials.

Embodiments of the invention are illustrated in drawings and described in detail below.

### BRIEF DESCRIPTION OF THE DRAWINGS

FIG. 1 is a schematic, sectional view of the rod ignition transformer of the invention with a cylindrical feedback.

FIG. 2 is a rod ignition transformer according to the invention having a cylindrical feedback with a full bridge to the central core on the low-voltage side.

FIG. 3 is a rod ignition transformer having a cylindrical feedback and a full bridge on the low-voltage side, and a partial bridge on the high-voltage side.

FIG. 4 is a rod ignition transformer according to the invention having a cylindrical feedback and a permanent magnet that is integrated into the core.

FIG. 5 is an integrated ignition unit comprising a rod ignition transformer according to the invention and additional electronics, as well as a spark plug.

### DETAILED DESCRIPTION OF THE PREFERRED EMBODIMENTS

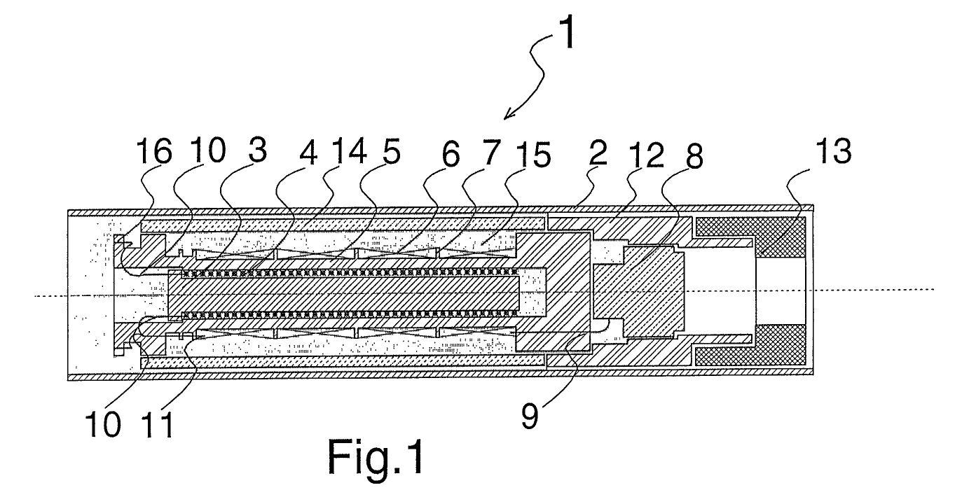

FIG. 1 shows a rod ignition transformer 1 having a housing 2. Disposed on a ferromagnetic powder-composite material core 3 disposed in the center of the housing 2 is a primary coil 4. A coil body 5 made of an insulating material surrounds the primary coil 4, and separates the primary coil from the secondary coil 6, which is wound onto the coil body 5. Separating ribs 7 of the coil body 5 subdivide the windings of the secondary coil 6 into a plurality of chambers. An electrical connection 9 connects a high-voltage connector 8 to one end of the secondary coil 6.

As indicated above, the powder composite material preferably has a relative magnetic permeability μ_{R} greater than 100, a specific electrical resistance p in a range of 0.5 Ωcm to 1*10⁴ Ωcm and, at 0.1 Tesla and 100 kHz, specific re-magnetization losses of less than 100 μWs/cm³ (microwatt seconds per cubic centimeter). Materials with these properties are known in the art and include a family of materials sold by the firm SMP Sintermetalle Promotheus, Ottostrasse 4,D-76676 Graben-Neudorf, Germany. Preferably, the ferromagnetic powder composite material used for the central core 3 is sold by that company under the designation “Pulverbundwerkstoff 1171”.

The primary coil 4 can be connected via connecting lines 10 to actuation electronics, not shown in FIG. 1. Likewise, the low-voltage side of the secondary coil 6 is connected via a connecting line 11 to electronics that are not shown and to one end of the primary coil 4. The high-voltage connector 8 is electrically insulated and mechanically fixed in the housing by a holder 12. The high-voltage connector 8 is preferably embodied as a high-voltage plug-and-socket connector. It is therefore possible to couple the rod ignition transformer directly, both mechanically and electrically, to a spark plug, not shown in this figure. A rubber-like insulation body 13 seals the housing on the high-voltage side, and insulates the rod ignition transformer against the porcelain insulation of a spark plug, not shown, when the rod ignition transformer is inserted onto a spark plug.

The primary coil 4 and the secondary coil 6 are surrounded by a cylindrical magnetic feedback member 14 for the magnetic flux. In one embodiment, a highly-permeable magnetic material having low eddy current losses forms the magnetic feedback member 14. In another embodiment, the feedback member 14 advantageously comprises ferrite. In a particularly preferred embodiment, the feedback member 14 is produced from a ferromagnetic powder composite material. Ferromagnetic materials having a relative permeability μ_{R} greater than 100 are preferred for the feedback 4.

The hollow spaces in the housing of the rod ignition transformer are cast with a casting compound 15 from the low-voltage side to the high-voltage connector 8 so as to be high-voltage-proof. In particular, the hollow spaces between the housing 2, the feedback member 14, the secondary coil 6, the coil body 5 and the primary coil 4 are cast with a casting compound 15 to be high-voltage-proof.

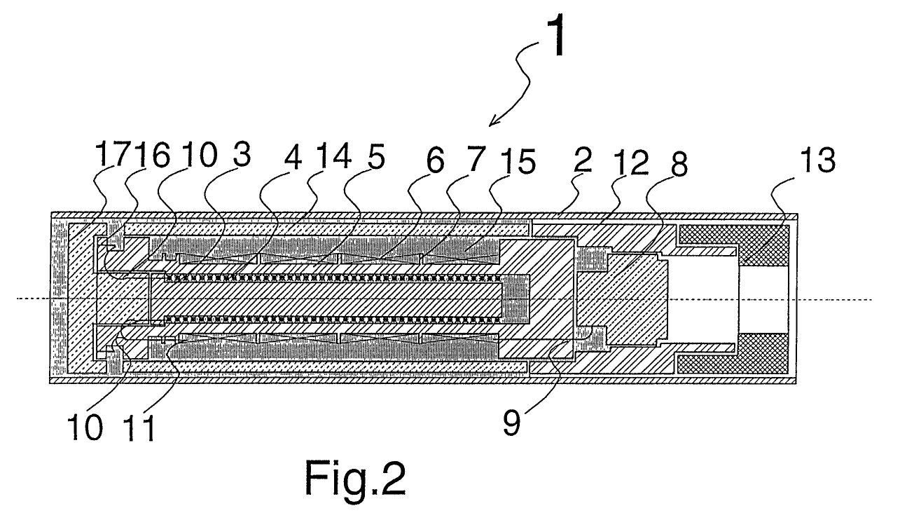

FIG. 2 illustrates a rod ignition transformer shown in FIG. 1, with an additional magnetic full bridge member 17 on the low-voltage side, which carries the magnetic flux in the magnetic feedback member 14 to the central core 3, so as little of the magnetic flux as possible extends into the surroundings of the rod ignition transformer, and no electromagnetic fields are radiated into the surroundings of the rod ignition transformer in the operation of the transformer.

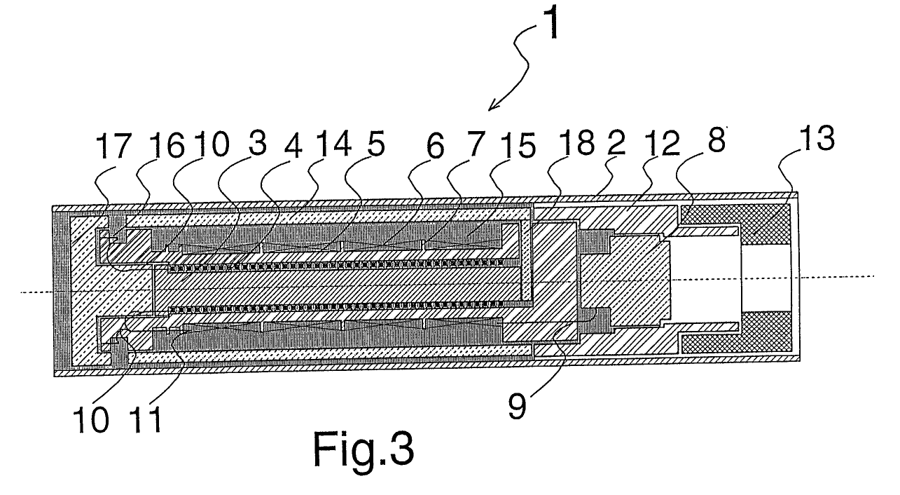

FIG. 3 illustrates a modification of the rod ignition transformer of FIG. 2, which additionally includes a magnetic partial bridge member 18 between the feedback member 14 and the central core 3 on the high-voltage side of the rod ignition transformer.

On the high-voltage side, the partial bridge 18 conducts the magnetic flux from the feedback member 14 to the central core 3, and thereby supports the full bridge member 17 on the low-voltage side.

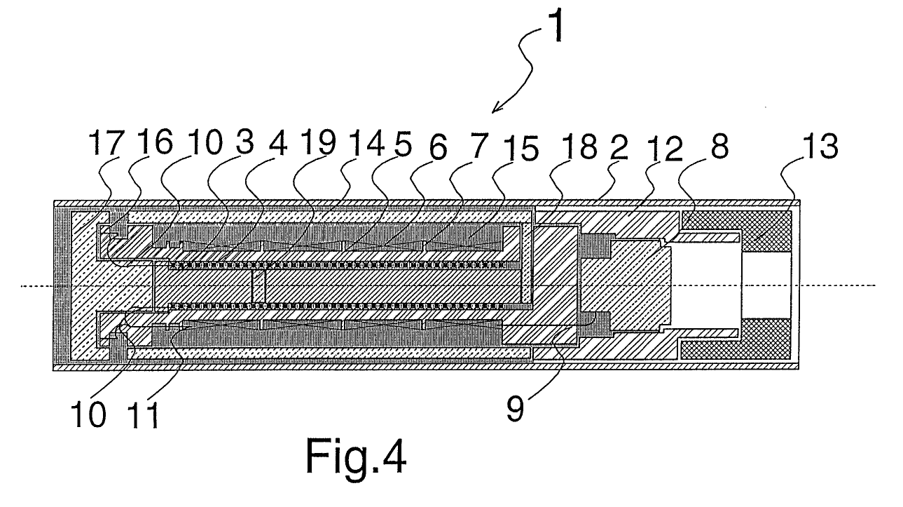

FIG. 4 depicts a modification of FIG. 3, with an additional permanent magnet 19, which is integrated into the central core 3. The permanent magnet 19 favorably influences the hysteresis properties of the magnetic materials of the ignition transformer, especially the magnetic feedback member 14 and the core 3. The permanent magnet 19 magnetically biases the magnetic materials of the ignition transformer, so these materials can be modulated higher before they reach their magnetic saturation. The magnetic field of the permanent magnet 19 predetermines a reference-field intensity, with which the magnetic materials of the ignition transformer are biased. The energy that can be stored in the ignition transformer can be purposefully influenced, depending on the intensity of the magnetic field of the permanent magnet 19. The higher the materials can be modulated in the B-H diagram (B: magnetic induction; H: magnetic field intensity) relative to a reference-field intensity, the more magnetic energy can be stored in the ignition transformer without changing the structural size.

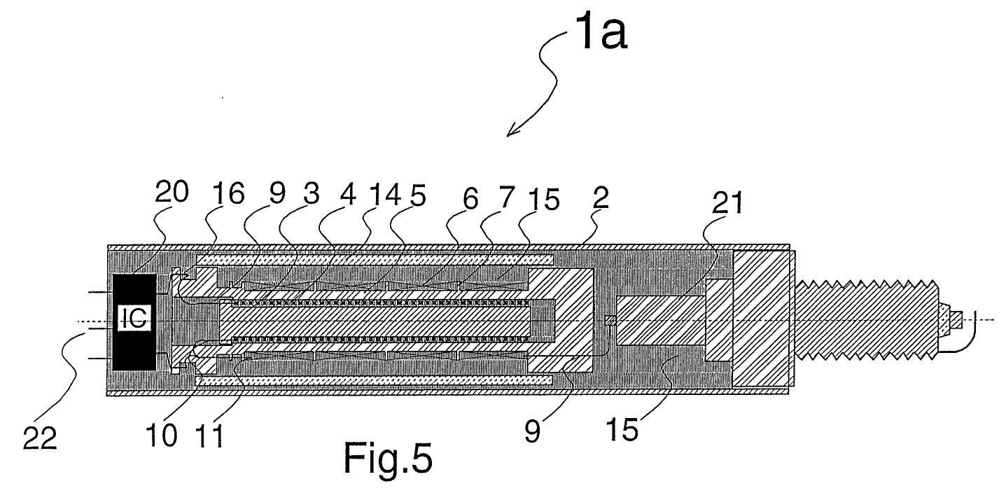

FIG. 5 shows an especially preferred embodiment of the invention. An integrated ignition unit 1a is formed by one of the rod ignition transformers from FIGS. 1 through 4, an integrated electronic component IC and a spark plug 21.

On the low-voltage side, the connectors 22 supply the electronic component IC with DC voltage. In a motor vehicle, the DC voltage is typically taken from the onboard network. The DC voltage is connected to the primary coil 4 of the rod ignition transformer via connector pins 16. Consequently, a secondary voltage is generated in the secondary coil 6 of the rod ignition transformer. The voltage level of this secondary voltage can be set via the winding ratio of the primary coil 3 to the secondary coil 6. A self-induction voltage occurs at the windings of the rod ignition transformer due to the interruption of the primary current of the rod ignition transformer. This self-induction voltage is used as the ignition voltage for the ignition spark, and can grow to 30 kV on the secondary side.

The secondary voltage is tapped from the secondary coil 6 and applied to the spark plug 21 via the connecting line 9. In the illustrated embodiment, the spark plug 21 was connected directly to the secondary coil via a connecting line 9. In this instance, the connecting line 9 simultaneously forms the high-voltage connector 8. A separate high-voltage connector 8, as shown in FIGS. 1 through 4, can then be omitted. It is also possible, however, to provide a rod ignition transformer with a separate high-voltage connector 8. It is particularly advantageous, in terms of producing the integrated ignition unit, for the high-voltage connector 8 to be embodied as a high-voltage plug-and-socket connector. In this case, the rod ignition transformer can specifically be joined with the spark plug 21 in the housing 2, which effects a preliminary fixing of the spark plug 21. This preliminary fixing can be made permanent by the casting of the entire housing interior with a high-voltage-proof casting compound. In the embodiment illustrated in FIG. 5, the spark plug 21 is directly embedded in the casting compound 15 without a preliminary fixing by a high-voltage plug-and-socket connector. The remaining hollow spaces in the housing can also be cast with a casting compound (15) to be high-voltage-proof.

The invention now being fully described, it will be apparent to one of ordinary skill in the art that many changes and modifications can be made thereto without departing from the spirit or scope of the invention as set forth herein.

What is claimed is:

1. A rod ignition transformer comprising a housing into which a low-voltage connector and a high-voltage connector are integrated; a central magnetic core on which a primary coil is wound; a coil body that surrounds the primary coil and on which a secondary coil is wound; a magnetic feedback member that is formed of a highly-permeable magnetic material having low eddy current losses; and wherein the central core is formed from a ferromagnetic powder composite material.

2. A rod ignition transformer according to claim 1, wherein the magnetic feedback member is cylindrical and surrounds the secondary winding.

3. A rod ignition transformer according to claim 1, wherein the high voltage connector is connected to one end of the secondary winding whose other end 19 is connected to the low voltage connector and to one end of the primary winding whose other end 19 is connected to the low voltage connector.

4. A rod ignition transformer according to claim 1, wherein the high-voltage connector is a high-voltage plug-and-socket connector.

5. The rod ignition transformer according to claim 1, wherein the magnetic feedback member is formed from a ferromagnetic material having a relative permeability greater than 100.

6. The rod ignition transformer according to claim 1, wherein the magnetic feedback member comprises ferrite.

7. The rod ignition transformer according to claim 1, wherein the magnetic feedback member is formed from a ferromagnetic powder composite material.

8. The rod ignition transformer according to claim 1, wherein on the low-voltage end, the magnetic feedback member is magnetically connected to the central core via a full bridge member.

9. The rod ignition transformer according to claim 8, wherein on the high-voltage side, the magnetic feedback member is magnetically connected to the central core via a magnetic partial bridge member.

10. The rod ignition transformer according to claim 1, wherein on the high-voltage side, the magnetic feedback member is magnetically connected to the central core via a magnetic partial bridge member.

11. The rod ignition transformer according to claim 1, wherein the central core includes an embedded magnet.

12. The rod ignition transformer according to claim 1, wherein any hollow spaces of the housing are cast with a casting compound, from the low-voltage side to the high-voltage connector, to be high-voltage-proof.

13. The rod ignition transformer according to claim 1, wherein the transformer is connected in an ignition system that is operated with a combination of self-induction and AC voltage.

14. An ignition unit having a rod ignition transformer according to claim 1, an electronic component (IC) and a spark plug: and wherein the rod ignition transformer, the electronic component (IC) and the spark plug are disposed in a single said housing, and form an integrated unit, with the spark plug being connected to the high-voltage plug and the electronic component being connected to the low-voltage connector.

15. The ignition unit according to claim 14, wherein any hollow spaces of the housing are cast with a casting compound.

16. The ignition unit according to claim 15 wherein the unit is connected in an ignition system that is operated with a combination of self-induction and AC voltage.

17. The rod ignition transformer according to claim 1, wherein the ferromagnetic powder composite material of the central core has a relative permeability greater than 100.

18. The rod ignition transformer according to claim 17. wherein the ferromagnetic powder composite material of the central core has a specific electrical resistance in a range of 0.05 to 1-10¹⁷ Ωcm.
